(19) United States
(12) Patent Application Publication
(10) Pub. No.: US 2005/0154871 A1
(43) Pub. Date: Jul. 14, 2005

(54) Method and apparatus for performing secure wireless communication with reduced bus traffic

(76) Inventors: Chu-Ming Lin, Hsinchu City (TW); Ko-Ming Chan, Hsinchu City (TW); Shih-Chang Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/751,693

(22) Filed: Jan. 5, 2004

(51) Int. Cl. H04L 9/00

(52) U.S. Cl. 713/150

(57) ABSTRACT

A method and apparatus for performing secure communication in a WLAN environment. According to the invention, a decryption table is provided, which includes several entries each having a number of sections to store at least one check item, at least one characteristic value, a secret key and a cipher type. The check item is employed to indicate which field of the encrypted packet needs to be compared with the characteristic value in the same entry of the decryption table. In response to receipt of an encrypted packet, one entry in sequence is selected from the decryption table. Then at least one field to be checked is extracted from the encrypted packet contingent on the check item in the selected entry. Upon successful matching of the extracted field to the characteristic value in the selected entry, the secret key and the cipher type in this entry are applied to decrypt the encrypted packet.

### BACKGROUND OF THE INVENTION

1. Field of the Invention

The invention relates to the field of wireless local area networks (WLANs), and more particularly to a scheme for performing secure wireless communication with reduced bus traffic in a computer system.

2. Description of the Related Art

A wireless local area network (WLAN) is a flexible data communications system that can either replace or extend a wired LAN to provide added functionality. Using radio frequency (RF) technology, WLANs transmit and receive data over the air, through walls, ceilings and even cement structures, without wired cabling. A WLAN provides all the features and benefits of traditional LAN technologies like Ethernet and Token Ring, but without the limitations of being tethered to a cable. This provides greatly increased freedom and flexibility.

The most common WLANs currently are those conforming to the IEEE 802.11 standard family. Not only are they increasingly deployed in private enterprise applications, but also in public applications such as airports and coffee shops. Since WLAN was designed as a wireless extension of the Ethernet for indoor use, it has adopted a simple protocol known as wired equivalent privacy (WEP) for authentication and encryption. According to WEP, every WLAN station and every access point in a Basic Service Set share a common, static key, called a WEP key. It has either 40 bits (standard) or 128 bits (optional). The authentication process is either an open authentication based on some advanced authentication method or a challenge and response authentication based on the WEP key. The encryption algorithm is RC4 with the key sequence generated by the WEP key and a random vector. However, the security flaws of WEP have been highly publicized, mainly due to the implementation flaw of the key scheduling algorithm in the RC4 encryption algorithm and the use of a static WEP key shared by every entity.

To address the security flaws related to WEP, the IEEE 802.1x standard has been introduced and the IEEE 802.11i standard is currently under development. Using the IEEE 802.1x standard along with various EAPs, or Extensible Authentication Protocols, WLAN authentication can be managed from a centralized server such as a RADIUS server, by means of session-specific keys for encryption purposes. Security flaws in the RC4 algorithm in WEP can be alleviated to some extent if the session-specific key is changed frequently. According to the IEEE 802.11i standard draft, the Advanced Encryption Standard (AES) will become the ultimate encryption algorithm to protect over-the-air traffic.

FIG. 1 illustrates a block diagram of a computer system according to related art. A network interface card (NIC) 130 installed in an expansion slot is coupled to a peripheral bus, such as a PCI bus 120. In the context of FIG. 1, CPU, main memory and bridge logic are referred to as a host subsystem 110 for brevity. The host subsystem 110 and NIC 130 are able to communicate with each other via the PCI bus 120. The NIC 130 is WLAN-enabled equipment and includes a security engine 140 to perform the security function. Owing to the very computationally intensive cryptographic operations, the security engine 140 merely carries out encryption and decryption while the host subsystem 110 assumes the rest of the work regarding encapsulation and decapsulation. When the NIC 130 receives a packet fragment across the radio medium, it first initiates a PCI cycle (identified by C1) so as to transfer the fragment to the host subsystem 110. In FIG. 1, the relevant PCI cycles are denoted by dotted lines with symbols C1, C2, and so on. The host subsystem 110 parses the packet fragment and then initiates a second PCI cycle C2 to transfer ciphertext data back to the NIC 130, where the ciphertext data is extracted from the packet fragment. The security engine 140 in the NIC 130 assumes the recovery of plaintext by decrypting the ciphertext data. After that, the NIC 130 initiates a further PCI cycle C3 to return the resulting plaintext to the host subsystem 110 for completion of the decapsulation process. It can be seen that a total of three PCI cycles is required for every decapsulation process. The encapsulation process is not described here but is essentially the reverse of the foregoing decapsulation process. In view of the above, there is heavy bus traffic on the PCI bus 120 during transmission and reception on WLANs. This results in a considerable performance penalty for the computer system.

Accordingly, what is needed is an efficient scheme for performing secure wireless communication with reduced bus traffic in a computer system, which addresses the problems of the related art.

### SUMMARY OF THE INVENTION

The present invention is generally directed to a method for performing secure communication in a WLAN environment. According to one aspect of the invention, the method first provides a decryption table. The decryption table includes several entries, each of which has a number of sections to store at least one check item, at least one characteristic value, a secret key and a cipher type. In response to receipt of an encrypted packet, one entry in sequence is selected from the decryption table. Then at least one field to be checked is extracted from the encrypted packet contingent on the check item in the selected entry. Upon successful matching of the extracted field to the characteristic value in the selected entry, the secret key and the cipher type in this entry are applied to decrypt the encrypted packet. If matching of the extracted field to the characteristic value is unsuccessful, the next entry in sequence is selected from the decryption table for comparison. Note that the check item indicates which field of the encrypted packet needs to be compared with the characteristic value in the same entry of the decryption table.

According to another aspect of the invention, an apparatus for performing secure communication in a WLAN environment is disclosed. The apparatus of the invention comprises a decryption table and a cryptography engine with access to the table. The decryption table is configured to include a number of entries; each entry has a number of sections to store at least one check item, at least one characteristic value, a secret key and a cipher type. The cryptography engine includes a means, responsive to receipt of an encrypted packet, for extracting from the encrypted packet at least one field to be checked contingent on the check item in a currently selected entry, sequentially chosen from the decryption table. The cryptography engine also includes a means for matching the extracted field of the encrypted packet to the characteristic value in the currently selected entry. Further, the cryptography engine has a means, upon successful matching, for applying the secret key and the cipher type in the currently selected entry to decrypt the encrypted packet. Note that the check item indicates which field of the encrypted packet needs to be compared with the characteristic value in the same entry of the decryption table.

### DESCRIPTION OF THE DRAWINGS

The present invention will be described by way of exemplary embodiments, but not limitations, illustrated in the accompanying drawings in which like references denote similar elements, and in which:

FIG. 1 is a block diagram of a computer system according to a related art;

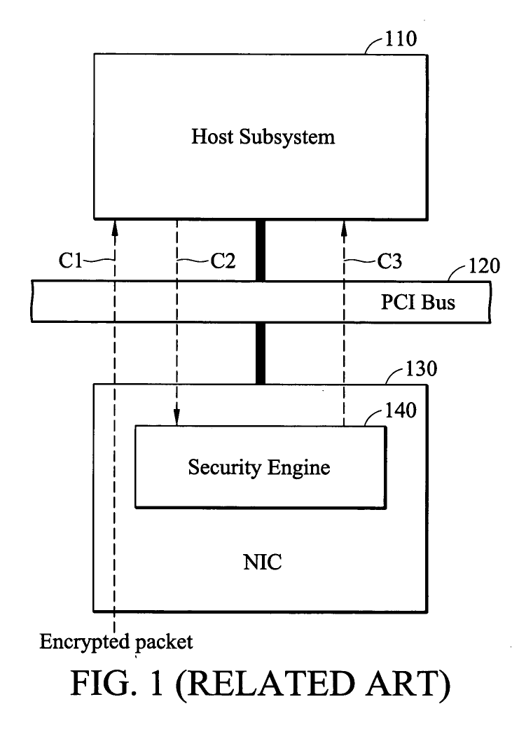

FIG. 2 is a block diagram of an exemplary computer according to an embodiment of the invention; and

FIG. 3 is a flowchart illustrating primary steps executed by a cryptography engine of FIG. 2 according to an embodiment of the invention.

### DETAILED DESCRIPTION OF THE INVENTION

With reference to the accompanying figures, an exemplary embodiment of the invention will now be described. The exemplary embodiment is described primarily with reference to a block diagram and flowchart. As to the flowchart, each block therein represents both a method step and an apparatus element for performing the method step. Herein, the apparatus element may be referred to as a means for, an element for, or a unit for performing the method step. Depending upon the implementation, the apparatus element, or portions thereof, may be configured in hardware, software, firmware or combinations thereof. As to the block diagram, it should be appreciated that not all components necessary for a complete implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described in detail.

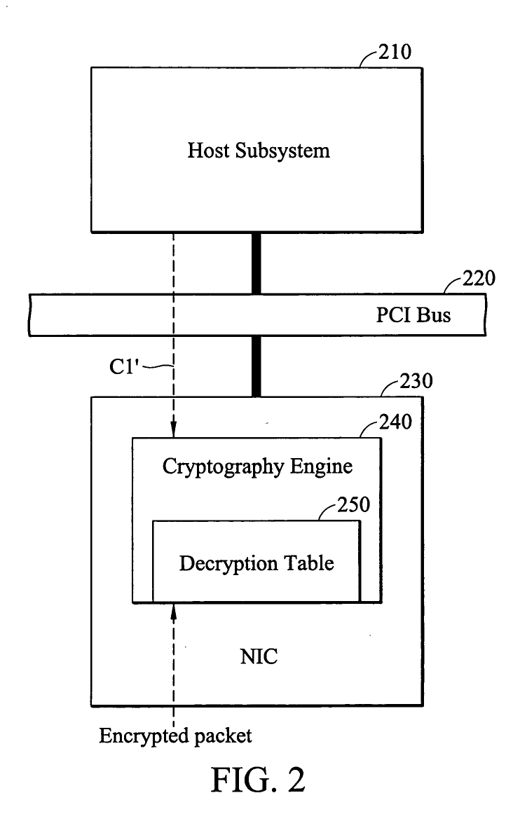

FIG. 2 illustrates an exemplary computer system useful in understanding the invention. The computer system includes a host subsystem 210 and a PCI bus 220 as mentioned earlier. A WLAN-enabled network interface card (NIC) 230 is connected to the PCI bus 220 through which transfers to and from the host subsystem 210 are performed. Notably, the NIC 230 has a cryptography engine 240 that is designed by the principle of the invention. The cryptography engine 240 includes a decryption table 250 having a number of entries, each of which has a number of sections to store check items, characteristic values, and output parameters, as shown in table 1 below. The check items are Key ID, Address 1, and Address 2; the characteristic values contain a 2-bit ID and 6-byte address; the output parameters include a security key and cipher type. The decryption table 250 is elaborately derived from decision trees in the IEEE 802.11 standard family. In 802.11, every data frame has a MAC header which contains a frame control field, duration/ID field, sequence control field, and four address fields: Addresses 1-4. Each of these address fields carries a 48-bit MAC address and has various uses depending on the source/destination of the frame and the mode in which the access point is operating. Address 1 typically indicates the 48-bit MAC address for the next receiver of the frame. Address 2 typically indicates the transmitter address. Addresses 3 and 4 are not employed as the check items in the decryption table 250. Furthermore, each encrypted frame conveys a Key ID to select one of four possible security key values for use in decrypting this frame. According to the invention, the entries must be listed in the decryption table 250 from the highest to lowest priority, and the check items of each entry indicate which fields within an encrypted frame need to be compared with the characteristic values in the same entry of the decryption table 250. In other words, a certain field of a received packet fragment must be subjected to a comparison with the relevant characteristic value if the check item corresponding to this field is marked in the same entry.

TABLE 1

| | CHECK ITEMS | | | CHARACTERISTIC | | OUTPUT PARAMETERS | |
|---|---|---|---|---|---|---|---|
| Entry | Key | Address | Address | VALUES | | Security | Cipher |
| Index | ID | 1 | 2 | ID | Address | Key | Type |
| 0 | ✓ | | | 3 | | 0123456789 | TKIP |
| 1 | | | ✓ | | 00-08-22-00-00-01 | ABCDEF0123 | AES-CCM |
| . | | | | | | | |
| . | | | | | | | |
| . | | | | | | | |
| 7 | | | | | | | |

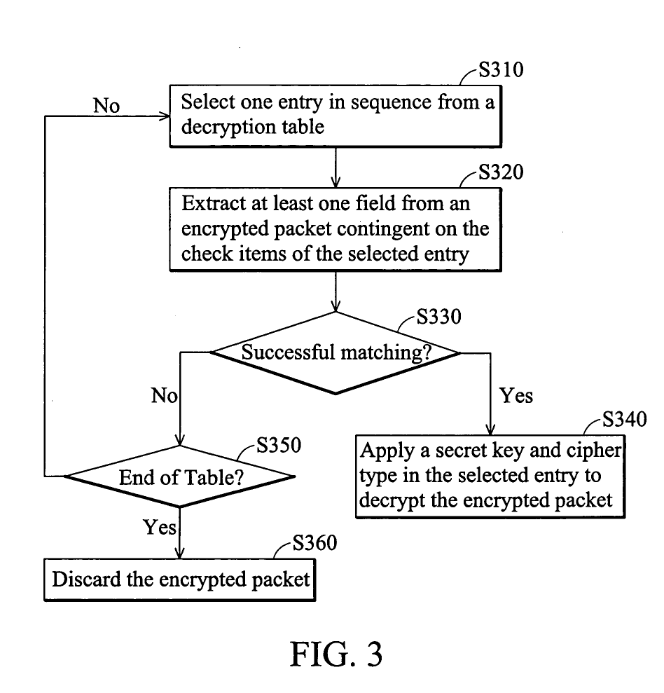

The invention is described in detail by way of examples when taken in conjunction with the flowchart of FIG. 3. To resolve the security problems with WEP, IEEE 802.11 TGi (Task Group i) is now developing new security protocols for 802.11 including TKIP (Temporal Key Integrity Protocol) and AES-based algorithms. Two AES-based proposals are AES-CCM and AES-OCB encapsulation protocols. However, the security protocols are beyond the scope of the invention and are not described in detail herein. In one scenario, a WLAN station (i.e. the computer system of FIG. 2) with a MAC address of 00-08-22-00-00-02 is associated to an access point (AP) with a MAC address of 00-08-22-00-00-01; broadcast data frames from the AP are encrypted with TKIP protocol, while unicast data frames are encrypted with AES-CCM protocol. Accordingly, the decryption table 250 is configured as table 1. When the WLAN station attempts to transmit a data frame, or packet fragments, the host subsystem 210 first sets necessary parameters in a transmit frame control block (TFCB) for this frame and initiates a PCI cycle to transfer the data frame with the TFCB to the NIC 230. With the cryptography engine 240, the data frame is then encapsulated using the security key and cipher type dictated by the TFCB. After that, the NIC 230 transmits the encrypted data frame over the radio medium. It can be seen that only one PCI cycle is required for every secure transmission.

When received, an encrypted packet or data frame is fed to the cryptography engine 240. In response thereto, the cryptography engine 240 first proceeds to step S310 where it selects one entry in sequence from the decryption table 250. Next, in step S320, the cryptography engine 240 extracts the at least one field to be checked from the encrypted packet contingent on the check items in the selected entry. As shown in table 1, for example, the first entry reveals that the check Key ID item has been marked, meaning the Key ID field of the received packet needs to be checked. In step S330, the cryptography engine 240 determines whether all check items are met. Assuming that the received packet conveys a Key ID of 3 and is broadcast from another station through the AP, the extracted Key ID field matches the 2-bit ID value of the first entry in this case. Upon successful matching, in step S340, the secret key and the cipher type in the selected entry can be applied to decrypt the received packet. Therefore, the cryptography engine 240 is able to completely recover plaintext data from this encrypted packet using TKIP with a key of ‘0123456789’ as set forth in the first entry of the decryption table 250. Finally, the NIC 230 initiates a PCI cycle (identified by C1′ in FIG. 2) in order to transfer the plaintext data to the host subsystem 210. In this way, only one PCI cycle is required for every secure reception.

If the NIC 230 receives from the AP another encrypted packet carrying a Key ID of 0, the cryptography engine 240 proceeds to step S310 where it selects the first entry from the decryption table 250 for this newly received packet. In step S320, the cryptography engine 240 extracts the field of Key ID from the encrypted packet contingent on the check item in the first entry. However, the extracted field does not match the 2-bit ID value of the first entry in this situation. When the matching is unsuccessful in step S330, the cryptography engine 240 proceeds through step S350 back to step S310 and then selects the next entry in sequence from the decryption table 250 for comparison. As shown in table 1, the second entry reveals that the Address 2 item has been marked, meaning the transmitter address field of the received packet needs to be checked. Hence, the cryptography engine 240 extracts the field of Address 2 (i.e. transmitter address) from the received packet in step S320 and compares it with the 6-byte address value in the second entry. Because the transmitter of this packet is the AP with the MAC address 00-08-22-00-00-01, the matching of the extracted field to the characteristic value is successful. The cryptography engine 240 then proceeds to step S340 where it completely recovers plaintext data from this encrypted packet using the AES-CCM protocol with a key of ‘ABCDEF 0123’ as set forth in the second entry of the decryption table 250. Note that the received packet may be undecryptable when the cryptography engine 240 proceeds to step S350 where it detects the end of the decryption table 250 and locates nothing for decapsulation. If so, the packet will be discarded in step S360.

In view of the above, the present invention provides a method and apparatus for performing secure wireless communication with reduced bus traffic in a computer system. In brief, the apparatus of the invention comprises a decryption table 250 and a cryptography engine 240 with access to the table 250. The decryption table 250 is configured to include a number of entries; each entry has a number of sections to store at least one check item, at least one characteristic value, a secret key and a cipher type. The cryptography engine 240 includes a means, responsive to receipt of an encrypted packet, for extracting from the encrypted packet at least one field to be checked contingent on the check item in a currently selected entry sequentially chosen from the decryption table. The cryptography engine also includes a means for matching the extracted field of the encrypted packet to the characteristic value in the currently selected entry. Further, the cryptography engine has a means, upon successful matching, for applying the secret key and the cipher type in the currently selected entry to decrypt the encrypted packet.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for performing secure wireless communication with reduced bus traffic in a computer system, comprising the steps of:
providing a decryption table having a plurality of entries each of which includes a plurality of sections to store at least one check item, at least one characteristic value, a secret key and a cipher type;
responsive to receipt of an encrypted packet,
sequentially selecting one entry from the decryption table;
extracting at least one field to be checked from the encrypted packet contingent on the check item in the selected entry; and
upon successful matching of the extracted field of the encrypted packet to the characteristic value in the selected entry, applying the secret key and the cipher type in the selected entry to decrypt the encrypted packet;
wherein the check item indicates which field of the encrypted packet needs to be compared with the characteristic value in the same entry of the decryption table.

2. The method as recited in claim 1 wherein the next entry in sequence is selected from the decryption table for comparison when the matching of the extracted field to the characteristic value is unsuccessful.

3. The method as recited in claim 1 wherein the entries are listed in the decryption table from the highest to lowest priority.

4. The method as recited in claim 1 wherein if the check item indicates that a Key ID needs to be checked, a field of Key ID within the encrypted packet is extracted and then compared with the characteristic value representing a predetermined key identifier.

5. The method as recited in claim 1 wherein if the check item indicates that a receiver address needs to be checked, a field of receiver address within the encrypted packet is extracted and then compared with the characteristic value representing a predetermined address.

6. The method as recited in claim 1 wherein if the check item indicates that a transmitter address needs to be checked, a field of transmitter address within the encrypted packet is extracted and then compared with the characteristic value representing a predetermined address.

7. An apparatus for performing secure wireless communication with reduced bus traffic in a computer system, comprising:
a decryption table configured to comprise a plurality of entries each of which includes a plurality of sections to store at least one check item, at least one characteristic value, a secret key and a cipher type; and
a cryptography engine with access to the decryption table, including:
means, responsive to receipt of an encrypted packet, for extracting from the encrypted packet at least one field to be checked contingent on the check item in a currently selected entry sequentially chosen from the decryption table;
means for matching the extracted field of the encrypted packet to the characteristic value in the currently selected entry; and
means, upon successful matching, for applying the secret key and the cipher type in the currently selected entry to decrypt the encrypted packet;
wherein the check item indicates which field of the encrypted packet needs to be compared with the characteristic value in the same entry of the decryption table.

8. The apparatus as recited in claim 7 wherein the next entry in sequence is selected from the decryption table for comparison when the matching of the extracted field to the characteristic value is unsuccessful.

9. The apparatus as recited in claim 7 wherein the decryption table keeps the entries in order from the highest to lowest priority.

10. The apparatus as recited in claim 7 wherein if the check item indicates that a Key ID needs to be checked, the extracting means can extract a field of Key ID within the encrypted packet, such that the matching means is then able to compare the extracted field of Key ID with the characteristic value representing a predetermined key identifier.

11. The apparatus as recited in claim 7 wherein if the check item indicates that a receiver address needs to be checked, the extracting means can extract a field of receiver address within the encrypted packet, such that the matching means is then able to compare the extracted field of receiver address with the characteristic value representing a predetermined address.

12. The apparatus as recited in claim 7 wherein if the check item indicates that a transmitter address needs to be checked, the extracting means can extract a field of transmitter address within the encrypted packet, such that the matching means is then able to compare the extracted field of transmitter address with the characteristic value representing a predetermined address.
